(19) United States
(12) Patent Application Publication
(10) Pub. No.: US 2026/0109285 A1
(43) Pub. Date: Apr. 23, 2026

(54) LOADING AND UNLOADING DEVICE

(71) Applicant: Matthew Shun, Glendale, CA (US)

(72) Inventor: Matthew Shun, Glendale, CA (US)

(21) Appl. No.: 18/983,581

(22) Filed: Dec. 17, 2024

Related U.S. Application Data
(60) Provisional application No. 63/710,053, filed on Oct. 22, 2024.

(51) Int. Cl. B60P 1/64

(52) U.S. Cl. CPC B60P 1/6427; B60P 1/6409

(57) ABSTRACT

A loading and unloading device is disclosed, wherein the loading and unloading device comprises an electric cable winch that is mounted on the front wall of the cargo container with a 5/16 inch diameter cable passing through a pulley, which is additionally attached to the front wall of the cargo container. Further, the cable is attached to a pallet wheeled dolly using a commercial U-style hook. The cable can be expanded and connected to several wheeled pallet dollies, all connected by U-style hooks. The cable is then used to pull the wheeled pallet dolly train out the back end of the cargo container onto the loading dock. Cargo is placed on the wheeled pallet dollies, and once loaded, the wheeled dollies are winched into the cargo container. The doors are secured, and the cargo container is transferred to its destination.

### CROSS-REFERENCE TO RELATED APPLICATION

The present application claims priority to, and the benefit of, U.S. Provisional Application No. 63/710,053, which was filed on Oct. 22, 2024, and is incorporated herein by reference in its entirety.

### FIELD OF THE INVENTION

The present invention relates generally to the field of loading and unloading devices. More specifically, the present invention relates to a winch system installed in cargo containers that helps load and unload cargo. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in loading and unloading devices. Generally, loading cargo containers in warehouses and retail environments requires a forklift. When forklifts are used to load the cargo containers, they create a bottleneck as roughly only one forklift can be operated within the cargo container at a time. Accordingly, trucks can take hours to load and unload, leaving little time for other tasks during a workday. Further, inefficient loading and unloading can lead to shipping delays.

Accordingly, there is a demand for an improved loading and unloading device that provides users with a winch system installed in cargo containers to help load and unload cargo. More particularly, there is a demand for a loading and unloading device that allows users to load and unload heavy cargo much quicker than via a forklift.

Therefore, there exists a long felt need in the art for a loading and unloading device that provides users with a winch system installed in cargo containers that helps load and unload cargo. There is also a long felt need in the art for a loading and unloading device that eliminates the need for forklifts to enter the cargo container, offering a much more effective and efficient loading and unloading method for cargo. Further, there is a long felt need in the art for a loading and unloading device that features an electric cable and winch system that attaches to the wall of the cargo container, allowing users to pull the cable to move the dollies. Moreover, there is a long felt need in the art for a device that allows users to load and unload heavy cargo much quicker than traditional methods. Further, there is a long felt need in the art for a loading and unloading device that includes a cable attached to the pallet wheeled dolly via a U-style hook. Finally, there is a long felt need in the art for a loading and unloading device that includes a handle to pull the dollies.

The subject matter disclosed and claimed herein, in one embodiment thereof, comprises a loading and unloading device. The device is a system for loading and unloading cargo containers with minimal use of a forklift to move the cargo. The loading and unloading device comprises an electric cable winch that is mounted on the front wall of the cargo container with a 5/16 inch diameter cable passing through a pulley, which is additionally attached to the front wall of the cargo container. Further, the cable is attached to a pallet wheeled dolly using a commercial U-style hook. The cable can be expanded and connected to several wheeled pallet dollies, all connected by U-style hooks. The cable is then used to pull the wheeled pallet dolly train out the back end of the cargo container onto the loading dock. Cargo is placed on the wheeled pallet dollies, and once loaded, the wheeled dollies are winched into the cargo container. The doors are secured, and the cargo container is transferred to its destination.

In this manner, the loading and unloading device of the present invention accomplishes all of the forgoing objectives and provides users with a winch system for loading and unloading cargo. The device is an electric cable winch and pulley system. The device also utilized a plurality of wheeled dollies.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a loading and unloading device. The loading and unloading device comprises a cable winch that is mounted on a cargo container with a cable passing through a pulley, which is additionally attached to the cargo container. Further, the cable is attached to a pallet wheeled dolly or multiple dollies. The cable is then used to pull the wheeled pallet dolly train out the back end of the cargo container onto the loading dock. Cargo is placed on the wheeled pallet dollies, and once loaded, the wheeled dollies are winched into the cargo container.

In one embodiment, the loading and unloading device allows users to load and unload heavy cargo much quicker than traditional methods. Thus, the device eliminates the need for forklifts to enter a cargo container, offering a much more effective and efficient loading and unloading method for cargo.

In one embodiment, the loading and unloading device comprises a cable winch and pulley that are secured to a cargo container. The winch is typically an electric winch but can be any suitable winch as is known in the art. The winch is mounted on a mounting bracket that is secured to the interior of the front wall of a cargo container or any other suitable storage container. In this manner, the winch is positioned in a location within the cargo container which facilitates correct ergonomic operation by an operator/user. The operator/user, while standing in an ergonomically correct position, is able to grasp the cable from the cable winch.

In one embodiment, the winch is a typical winch as is known in the art. Generally, the winch comprises a cable made up of a braided synthetic rope or a steel cable wrapped around a motorized drum, and it is controlled electronically. Typically, an electric winch operates on 12 volts and offers steel cable or synthetic rope options to pull multiple thousand pounds.

In one embodiment, the winch includes a pulley, which can be any suitable pulley as is known in the art. Typically, the winch and pulley consists of two parts: a drum and a sheave. The drum is where the cord or cable goes around, and the sheave is what holds the rope or cable in place when rotated. The sheave allows the pulley to lift something by pulling on the attached cable through the operation mechanism and tensioning the cable Typically, a 5/16 inch diameter cable is passed through the pulley for use.

In one embodiment, the cable comprises a handle which allows a user to easily pull the cable during use.

In one embodiment, a pallet wheeled dolly is utilized to transport heavy cargo and other suitable cargo needing transport. The construction and arrangement of the dolly according to the invention enables a heavy load to be engaged by the operator/user by placing the cargo on the pallet. The operator/user may then operate the winch to wheel the load to a required unloading position in a conventional manner. This is particularly suitable for loading a heavy load onto a cargo container, or into the back of any other suitable motor vehicle.

In one embodiment, the pallet wheeled dolly comprises a pallet with a top and bottom surface. The pallet can be any suitable size and shape as is known in the art, but typically is configured in a square or rectangular shape. The pallet is a load supporting chassis and the top surface is where the cargo is placed and the bottom surface has a plurality of wheels attached. Typically, there is a wheel/caster secured to each corner of the pallet to allow the device to move freely, as needed. The wheels/casters allow the device to swivel and roll easily across a floor or other suitable surface. Additionally, the wheels/casters can be locked in place for safety, to prevent the device from inadvertently rolling. Further, the pallet comprises a U-shaped handle or other suitable handle. The handle is utilized by a user to move the device via the wheels/casters across the floor rather than a user bending over and moving/pushing it and risking discomfort.

In one embodiment, in use, the cable is attached to the pallet wheeled dolly using a commercial U-style hook. In another embodiment, the cable can be expanded and connected to several wheeled pallet dollies in a row, all connected by U-style hooks. The cable from the winch and pulley is then used to pull the wheeled pallet dolly train, via the handle, out the back end of the cargo container onto the loading dock. Cargo is placed on the wheeled pallet dollies, and once loaded, the wheeled dollies are winched into the cargo container. The doors are secured, and the cargo container is transferred to its destination.

In yet another embodiment, the loading and unloading device comprises a plurality of indicia.

In yet another embodiment, a method of easily unloading and loading cargo is disclosed. The method includes the steps of providing a loading and unloading device comprising an electric cable winch and pulley secured to a cargo container. The method also comprises securing the cable to a wheeled pallet dolly. Further, the method comprises securing several wheeled pallet dollies together. The method also comprises loading cargo onto the wheeled pallet dollies. Finally, the method comprises winching the dollies into the cargo container for transport.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the loading and unloading device of the present invention showing the winch and pulley inside the cargo container in accordance with the disclosed architecture;

FIG. 2 illustrates a perspective view of one embodiment of the loading and unloading device of the present invention showing the wheeled pallet dollies in accordance with the disclosed architecture;

FIG. 3 illustrates a perspective view of one embodiment of the loading and unloading device of the present invention showing the cable handle in accordance with the disclosed architecture;

FIG. 4 illustrates a perspective view of one embodiment of the loading and unloading device of the present invention showing the handle in use to pull the dollies in accordance with the disclosed architecture;

FIG. 5 illustrates a perspective view of one embodiment of the loading and unloading device of the present invention showing how heavy cargo is easily loaded and unloaded in accordance with the disclosed architecture; and

FIG. 6 illustrates a flowchart showing the method of easily unloading and loading cargo in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a loading and unloading device that provides users with a winch system installed in cargo containers that helps load and unload cargo. There is also a long felt need in the art for a loading and unloading device that eliminates the need for forklifts to enter the cargo container, offering a much more effective and efficient loading and unloading method for cargo. Further, there is a long felt need in the art for a loading and unloading device that features an electric cable and winch system that attaches to the wall of the cargo container, allowing users to pull the cable to move the dollies. Moreover, there is a long felt need in the art for a device that allows users to load and unload heavy cargo much quicker than traditional methods. Further, there is a long felt need in the art for a loading and unloading device that includes a cable attached to the pallet wheeled dolly via a U-style hook. Finally, there is a long felt need in the art for a loading and unloading device that includes a handle to pull the dollies.

The present invention, in one exemplary embodiment, is a novel loading and unloading device. The loading and unloading device comprises an electric cable winch that is mounted on the front wall of the cargo container with a 5/16 inch diameter cable passing through a pulley, which is additionally attached to the front wall of the cargo container. Further, the cable is attached to a pallet wheeled dolly using a commercial U-style hook. The cable can be expanded and connected to several wheeled pallet dollies, all connected by U-style hooks. The cable is then used to pull the wheeled pallet dolly train out the back end of the cargo container onto the loading dock. Cargo is placed on the wheeled pallet dollies, and once loaded, the wheeled dollies are winched into the cargo container. The doors are secured, and the cargo container is transferred to its destination. The present invention also includes a novel method of easily unloading and loading cargo. The method includes the steps of providing a loading and unloading device comprising an electric cable winch and pulley secured to a cargo container. The method also comprises securing the cable to a wheeled pallet dolly. Further, the method comprises securing several wheeled pallet dollies together. The method also comprises loading cargo onto the wheeled pallet dollies. Finally, the method comprises winching the dollies into the cargo container for transport.

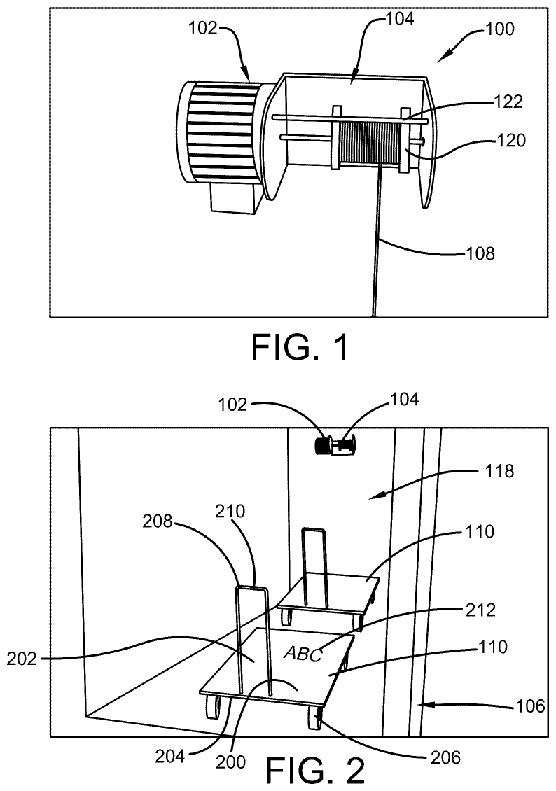

Referring initially to the drawings, FIG. 1 illustrates a perspective view of one embodiment of the loading and unloading device 100 of the present invention. In the present embodiment, the loading and unloading device 100 is an improved loading and unloading device 100 that provides a user 116 with a winch system for loading/unloading cargo 114. Specifically, the loading and unloading device 100 comprises a cable winch 102 and pulley 104 mounted on a cargo container 106. Further, the cable 108 is attached to a pallet wheeled dolly 110 or multiple dollies 110. The cable 108 is then used to pull the wheeled pallet dolly 110 train out the back end 112 of the cargo container 106 onto the loading dock. Cargo 114 is placed on the wheeled pallet dollies 110, and once loaded, the wheeled dollies 110 are winched into the cargo container 106.

Generally, the loading and unloading device 100 allows users 116 to load and unload heavy cargo 114 much quicker than traditional methods. Thus, the device 100 eliminates the need for forklifts to enter a cargo container 106, offering a much more effective and efficient loading and unloading method for cargo 114.

Further, the loading and unloading device 100 comprises a cable winch 102 and pulley 104 that are secured to a cargo container 106. The winch 102 is typically an electric winch but can be any suitable winch as is known in the art. The winch 102 is mounted on a mounting bracket that is secured to the interior of the front wall 118 of a cargo container 106 or any other suitable storage container. In this manner, the winch 102 is positioned in a location within the cargo container 106 which facilitates correct ergonomic operation by an operator/user 116. The operator/user 116, while standing in an ergonomically correct position, is able to grasp the cable 108 from the cable winch 102 during use.

As stated supra, the winch 102 is a typical winch as is known in the art. Generally, the winch 102 comprises a cable 108 made up of a braided synthetic rope or a steel cable wrapped around a motorized drum 120, and it is controlled electronically. Typically, an electric winch 102 operates on 12 volts and offers steel cable or synthetic rope options to pull multiple thousand pounds.

Further, the winch 102 of the disclosed invention, includes a pulley 104, which can be any suitable pulley as is known in the art. Typically, the winch 102 and pulley 104 consists of two parts: a drum 120 and a sheave 122. The drum 120 is where the cord or cable 108 goes around, and the sheave 122 is what holds the rope or cable 108 in place when rotated. The sheave 122 allows the pulley 104 to lift something by pulling on the attached cable 108 through the operation mechanism and tensioning the cable 108. Typically, a 5/16 inch diameter cable 108 is passed through the pulley 104 and sheave 122 for use, but any suitable size cable 108 can be utilized as is known in the art.

As shown in FIG. 2, a pallet wheeled dolly 110 is utilized to transport heavy cargo 114 and other suitable cargo needing transport. The construction and arrangement of the dolly 110 according to the invention enables a heavy load to be engaged by the operator/user 116 by placing the cargo 114 on the pallet 200. The operator/user 116 may then operate the winch 102 to wheel the load to a required unloading position in a conventional manner. This is particularly suitable for loading a heavy load onto a cargo container 106, or into the back of any other suitable motor vehicle for transport.

Further, the pallet wheeled dolly 110 comprises a pallet 200 with a top 202 and bottom 204 surface. The pallet 200 can be any suitable size and shape as is known in the art, but typically is configured in a square or rectangular shape. The pallet 200 is a load supporting chassis and the top surface 202 is where the cargo 114 is placed and the bottom surface 204 has a plurality of wheels 206 attached. Typically, there is a wheel/caster 206 secured to each corner of the pallet 200 to allow the device 100 to move freely, as needed. The wheels/casters 206 allow the device 100 to swivel and roll easily across a floor or other suitable surface. Additionally, the wheels/casters 206 can be locked in place for safety, to prevent the device 100 from inadvertently rolling. In another embodiment, the wheels 206 are rugged, all-terrain wheels, allowing a user 116 to more easily manipulate the dolly 110 over debris and rough terrain, as needed. The plurality of wheels 206 can be secured to the pallet 200 via any suitable securing means as is known in the art, such as bolts, screws, pins, etc. Further, any suitable wheels 206 can be utilized as is known in the art, such as castors, rollers, heavy-duty wheels, large tread wheels, swivel wheels, etc.

Additionally, the pallet 200 comprises a U-shaped handle 208 or another suitable handle. The handle 208 is utilized by a user 116 to move the device 100 via the wheels/casters 206 across the floor rather than a user 116 bending over and moving/pushing it and risking discomfort. The handle 208 is secured to the pallet 200 via any suitable securing means as is known in the art, such as welding, adhesives, mechanical fasteners, etc. Further, the handle 208 can be any suitable handle as is known in the art, as long as the handle 208 allows a user 116 to securely and comfortably move the pallet dolly 110, as needed. Additionally, the handle 208 can comprise gripping texture areas 210 or other suitable non-slip resistant areas to provide a non-slip grip for a user 116.

In yet another embodiment, the loading and unloading device 100 comprises a plurality of indicia 212. The pallet dolly 110 of the device 100 may include advertising, a trademark, or other letters, designs, or characters, printed, painted, stamped, or integrated into the pallet dolly 110, or any other indicia 212 as is known in the art. Specifically, any suitable indicia 212 as is known in the art can be included, such as but not limited to, patterns, logos, emblems, images, symbols, designs, letters, words, characters, animals, advertisements, brands, etc., that may or may not be cargo, dolly, or brand related.

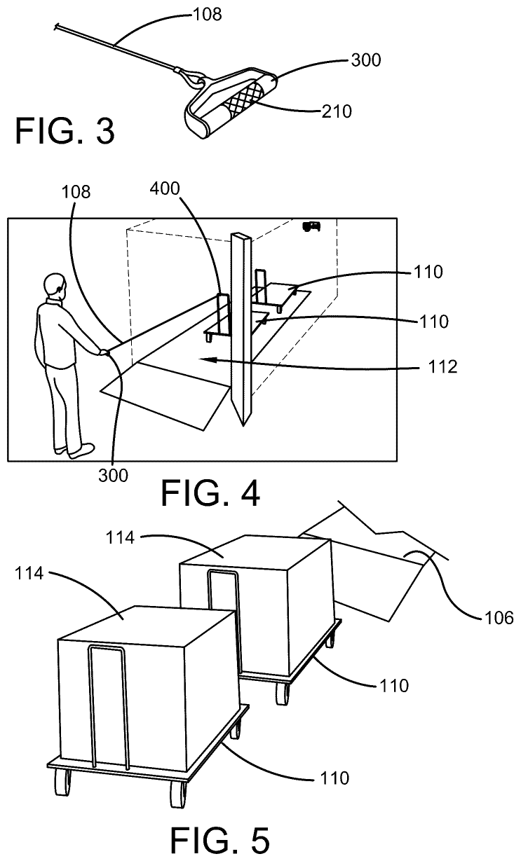

As shown in FIG. 3, the cable 108 comprises a handle 300 which allows a user 116 to easily pull the cable 108 during use. The handle 300 is secured to the cable 108 via any suitable securing means as is known in the art, such as welding, adhesives, mechanical fasteners, etc. Further, the handle 300 can be any suitable handle as is known in the art, as long as the handle 300 allows a user 116 to securely and comfortably pull the cable 108, as needed. Additionally, the handle 300 can comprise gripping texture areas 210 or other suitable non-slip resistant areas to provide a non-slip grip for a user 116.

As shown in FIGS. 4-5, in use, the cable 108 is attached to the pallet wheeled dolly 110 using a commercial U-style hook 400 or other suitable securing means as is known in the art. In another embodiment, the cable 108 can be expanded and connected to several wheeled pallet dollies 110 in a row, all connected by U-style hooks 400. The cable 108 from the winch 102 and pulley 104 is then used to pull the wheeled pallet dolly 110 train, via the cable handle 300, out the back end 112 of the cargo container 106 onto the loading dock. Cargo 114 is placed on the wheeled pallet dollies 110, and once loaded, the wheeled dollies 110 are winched into the cargo container 106. The doors are secured, and the cargo container 106 is transferred to its destination to be unloaded.

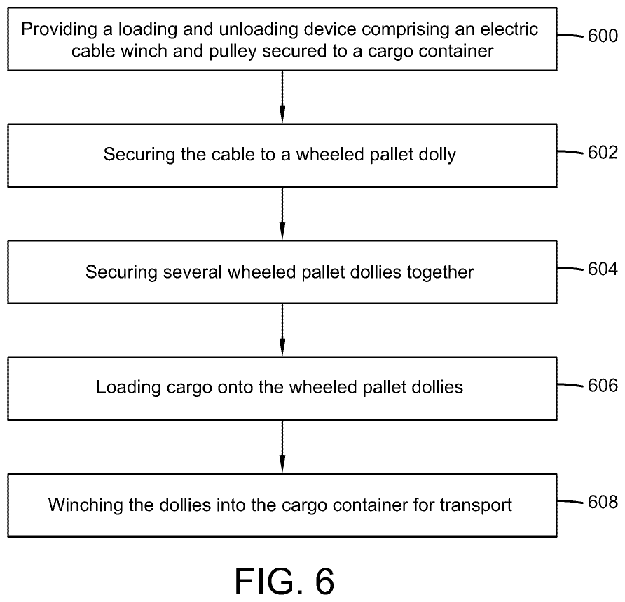

FIG. 6 illustrates a flowchart of the method of easily unloading and loading cargo. The method includes the steps of at 600, providing a loading and unloading device comprising an electric cable winch and pulley secured to a cargo container. The method also comprises at 602, securing the cable to a wheeled pallet dolly. Further, the method comprises at 604, securing several wheeled pallet dollies together. The method also comprises at 606, loading cargo onto the wheeled pallet dollies. Finally, the method comprises at 608, winching the dollies into the cargo container for transport.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “loading and unloading device” and “device” are interchangeable and refer to the loading and unloading device 100 of the present invention.

Notwithstanding the forgoing, the loading and unloading device 100 of the present invention can be of any suitable size and configuration as is known in the art without affecting the overall concept of the invention, provided that it accomplishes the above stated objectives. One of ordinary skill in the art will appreciate that the loading and unloading device 100 as shown in FIGS. 1-6 is for illustrative purposes only, and that many other sizes and shapes of the loading and unloading device 100 are well within the scope of the present disclosure. Although the dimensions of the loading and unloading device 100 are important design parameters for user convenience, the loading and unloading device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A loading and unloading device that provides a user with a winch system for cargo, the loading and unloading device comprising:
a winch;
a pulley; and
at least one pallet dolly;
wherein the winch and the pulley are mounted on a cargo container;
wherein the winch and the pulley comprise a cable;
wherein the cable is secured to at least one pallet dolly; and
further wherein the cable is used to pull the at least one pallet dolly out of the cargo container, where it can be loaded and winched back into the cargo container for transport.

2. The loading and unloading device of claim 1, wherein the winch is an electric winch.

3. The loading and unloading device of claim 2, wherein the pulley comprises a drum that the cable is wrapped around and a sheave which holds the cable in place when rotated.

4. The loading and unloading device of claim 3, wherein the cable is a 5/16 inch diameter steel cable which is passed through the pulley and sheave for use.

5. The loading and unloading device of claim 4, wherein the at least one pallet dolly comprises a pallet with a top and bottom surface.

6. The loading and unloading device of claim 5, wherein the top surface is where cargo is placed and the bottom surface has a plurality of wheels attached.

7. The loading and unloading device of claim 6, wherein there is a wheel secured to each corner of the bottom surface of the pallet.

8. The loading and unloading device of claim 7, wherein the plurality of wheels can be locked in place for safety, to prevent the loading and unloading device from inadvertently rolling.

9. The loading and unloading device of claim 8, wherein the pallet comprises a U-shaped handle.

10. The loading and unloading device of claim 9 further comprising a plurality of indicia.

11. The loading and unloading device of claim 10, wherein the cable comprises a handle which allows a user to easily pull the cable during use.

12. The loading and unloading device of claim 11, wherein the cable is attached to the at least one pallet dolly using a commercial U-style hook.

13. The loading and unloading device of claim 12, wherein the cable is expanded and connected to several pallet dollies in a row, all connected by U-style hooks.

14. A loading and unloading device that provides a user with a winch system for cargo, the loading and unloading device comprising:
an electric winch and cable;
a pulley comprising a drum that the cable is wrapped around and a sheave which holds the cable in place when rotated; and
at least one pallet dolly comprising a pallet with a top and bottom surface, a plurality of wheels, and a handle;
wherein the winch and the pulley are mounted on a cargo container;
wherein the cable comprises a handle which allows a user to easily pull the cable during use;
wherein the cable is secured to at least one pallet dolly using a commercial U-style hook;
wherein the cable is expanded and connected to several pallet dollies in a row, all connected by U-style hooks;
wherein the handle of the cable is used to pull the several pallet dollies in a row out of the cargo container;
wherein the several pallet dollies are loaded with cargo; and
further wherein the several pallet dollies are winched back into the cargo container for transport.

15. The loading and unloading device of claim 14, wherein the handle for the at least one pallet dolly comprises gripping texture areas to provide a non-slip grip for a user.

16. The loading and unloading device of claim 14, wherein the cable is a 5/16 inch diameter steel cable which is passed through the pulley and sheave for use.

17. The loading and unloading device of claim 14, wherein the plurality of wheels can be locked in place for safety, to prevent the loading and unloading device from inadvertently rolling.

18. The loading and unloading device of claim 14, wherein the top surface is where cargo is placed and the bottom surface has a plurality of wheels attached.

19. The loading and unloading device of claim 14, wherein the handle for the cable comprises gripping texture areas to provide a non-slip grip for a user.

20. A method of easily unloading and loading cargo, the method comprising the following steps:
providing a loading and unloading device comprising an electric cable winch and pulley secured to a cargo container;
securing the cable to a wheeled pallet dolly;
securing several wheeled pallet dollies together;
loading cargo onto the wheeled pallet dollies; and
winching the dollies into the cargo container for transport.
